(19) United States
(12) Patent Application Publication
(10) Pub. No.: US 2026/0104665 A1
(43) Pub. Date: Apr. 16, 2026

(54) FIXING APPARATUS, AND MANUFACTURING METHOD

(71) Applicant: CANON KABUSHIKI KAISHA, Tokyo (JP)

(72) Inventor: HITOSHI MURAO, Tokyo (JP)

(21) Appl. No.: 19/348,367

(22) Filed: Oct. 2, 2025

(30) Foreign Application Priority Data
Apr. 17, 2025 (JP) 2025-068458
Oct. 10, 2024 (JP) 2024-177948

(51) Int. Cl. G03G 15/20

(52) U.S. Cl. CPC G03G 15/2057; G03G 15/206; G03G 15/2064; G03G 2215/2032

(57) ABSTRACT

A fixing apparatus includes a rotatable endless belt, a pressure roller, the pad member, wherein the pad member includes a contact member and a holding member, wherein the contact member has a plurality of projecting portions on a first surface, and a plurality of recessed portions in a second surface, wherein, in a direction perpendicularly intersecting with a conveyance direction, an outline of each of the plurality of recessed portions is within a more centrally inward range than an outline of a base portion of each of the plurality of projecting portions, and wherein a depth of a deepest portion of each of the recessed portions in the direction perpendicularly intersecting with the conveyance direction is shorter than a thickness of the contact member with respect to a predetermined reference plane where neither a projecting portion nor a recessed portion is formed.

### BACKGROUND

### Field of the Technology

The present disclosure relates to a fixing apparatus suitable for printers, copiers, facsimiles, multifunction peripherals, and other image forming apparatuses employing electrophotographic technology, and a manufacturing method.

### Description of the Related Art

An image forming apparatus includes a fixing apparatus for applying heat and pressure to a recording material with an unfixed toner image formed thereon to fix the toner image to the recording material.

The fixing apparatus includes an endless fixing belt, a roller (a pressure roller) in contact with the outer circumferential surface of the fixing belt, a slide member for pressing the fixing belt from its inner circumferential surface to the roller, and a stay for supporting the slide member.

This fixing apparatus includes a fixing nip portion formed between the fixing belt and the roller. When the heated and pressed recording material is conveyed and pinched through the fixing nip portion, the toner image is fixed to the recording material.

The slide member presses the fixing belt from its inner circumferential surface to the fixing nip portion to ensure the nip pressure on the fixing belt.

In recent years, there has been the demand for further reducing the time taken from a room temperature (when power is turned on) to a predetermined temperature (a reload temperature) at which printing is enabled, i.e., the warm-up time.

There has been another demand for reducing the time taken from a print operation after a printing preparation, in response to receiving a printing request, to the completion of a discharge operation, i.e., the first printing time.

As described in Japanese Patent Laid-Open No. 2016-053632, a method has been conventionally employed of improving thermal insulating performance referring to insulation of heat transfer from the slide member to the stay and other parts by using a heat insulation material.

### SUMMARY

According to an aspect of the present disclosure, a fixing apparatus for fixing a toner image borne on a recording material to the recording material at a nip portion, the fixing apparatus includes a rotatable endless belt configured to heat the recording material, a pressure roller configured to abut an outer circumferential surface of the belt, and configured to press the belt, and a pad member disposed inside an inner circumference surface of the belt, the pad member facing the pressure roller across the belt, and configured to form the nip portion between the belt and the pressure roller, wherein the pad member includes a contact member in contact with the inner circumference surface of the belt, and a holding member that holds the contact member, wherein the contact member has a plurality of projecting portions on a first surface of the contact member, the first surface being to slide with the inner circumferential surface of the belt, and a plurality of recessed portions in a second surface of the contact member, the second surface being to be in contact with the holding member, wherein, in a direction perpendicularly intersecting with a conveyance direction, an outline of each of the plurality of recessed portions is within a more centrally inward range than an outline of a base portion of each of the plurality of projecting portions, and wherein a depth of a deepest portion of each of the recessed portions in the direction perpendicularly intersecting with the conveyance direction is shorter than a thickness of the contact member with respect to a predetermined reference plane where neither a projecting portion nor a recessed portion is formed.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating a configuration of an image forming apparatus according to a first embodiment.

FIG. 2 is a schematic diagram illustrating a fixing apparatus according to the first embodiment.

FIG. 3 is a schematic perspective view of a slide member according to the first embodiment.

FIG. 4 is a perspective cross-sectional view of a feature of the slide member according to the first embodiment.

FIG. 5 is a partial cross-sectional view of the slide member and a holding member according to the first embodiment.

FIG. 6 is a perspective cross-sectional view of a feature of a slide member according to a second embodiment.

FIG. 7 is a partial cross-sectional view of the slide member according to the second embodiment.

FIG. 8 is a partial top view illustrating an example of a recessed shape according to the second embodiment.

FIG. 9 is a partial top view and a partial cross-sectional view illustrating another example of the recessed shape according to the second embodiment.

FIG. 10 is a partial top view and a partial cross-sectional view illustrating still another example of the recessed shape according to the second embodiment.

FIG. 11 is a partial top view and a partial cross-sectional view illustrating still another example of the recessed shape according to the second embodiment.

FIGS. 12A to 12E are schematic cross-sectional views illustrating a press forming method for the slide member.

### DESCRIPTION OF THE EMBODIMENTS

A fixing apparatus according to an embodiment of the present disclosure will be described below with reference to the accompanying drawings.

The following embodiments are as illustrative. For example, detailed configurations can be modified as appropriate by those skilled in the art without departing from the spirit of the present disclosure.

In the drawings to be referenced in the following description, elements assigned the same reference numerals have similar functions unless otherwise specifically described.

A first embodiment will be described.

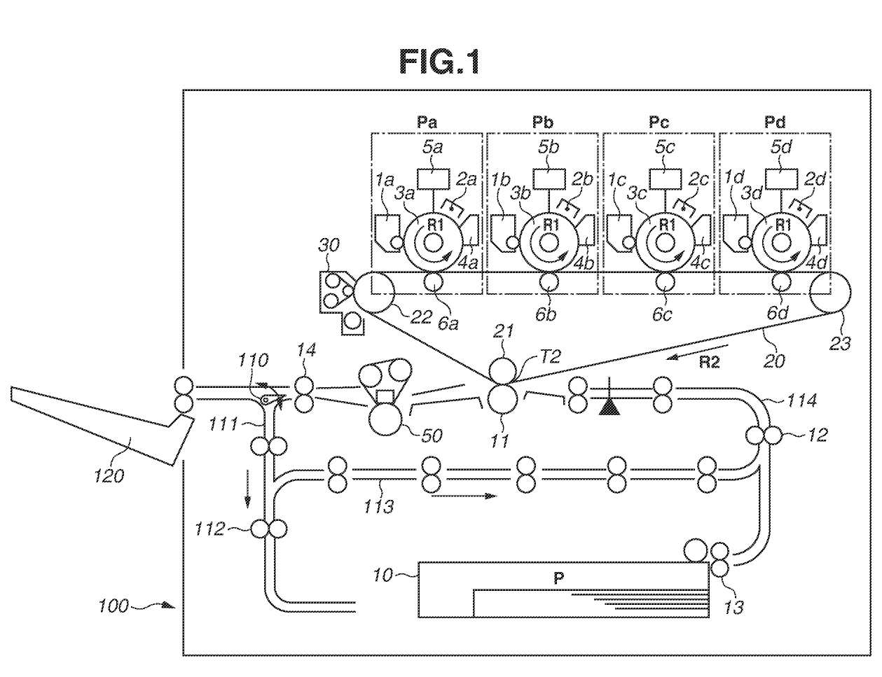

An image forming apparatus suitable to use a fixing apparatus according to the present embodiment will be described with reference to FIG. 1.

An image forming apparatus 100 illustrated in FIG. 1 is a tandem-type full-color printer using an intermediate transfer method in which image forming units Pa, Pb, Pc, and Pd for yellow, magenta, cyan, and black, respectively, are disposed along an intermediate transfer belt 20.

A recording material conveyance process of the image forming apparatus 100 will be described.

Recording materials P are stored in a stacked way in a sheet cassette 10 and sent from the sheet cassette 10 by a feed roller 13 in synchronization with the image forming timing.

A recording material P sent by the feed roller 13 is conveyed to a registration roller 12 disposed on a conveyance path 114.

Then, after being subjected to skew correction and timing correction by the registration roller 12, the recording material P is sent to a secondary transfer portion T2.

The secondary transfer portion T2 is a transfer nip portion formed by an inner secondary transfer roller 21 and an outer secondary transfer roller 11. When a secondary transfer voltage is applied to the outer secondary transfer roller 11, the toner image is transferred onto the recording material P.

The process of conveying the recording material P to the secondary transfer portion T2 has been described above. A process of forming an image sent to the secondary transfer portion T2 at a similar timing will now be described.

First, the image forming units will be described. The image forming units Pa, Pb, Pc, and Pd for different colors are configured in almost the same way, except for the toner color (yellow, magenta, cyan, and black) used by development devices 1a, 1b, 1c, and 1d, respectively.

For this reason, the image forming unit Pd for black alone will be described, and descriptions of other image forming units Pa, Pb, and Pc will be omitted.

The image forming unit Pd mainly includes the development device 1d, a charging device 2d, a photosensitive drum 3d, a photosensitive drum cleaner 4d, and an exposure device 5d.

In FIG. 1, the surface of the photosensitive drum 3d rotating in the direction of the arrow R1 is uniformly pre-charged by the charging device 2d. Then, an electrostatic latent image is formed by the exposure device 5d driven based on image information signals.

Then, the electrostatic latent image formed on the photosensitive drum 3d is developed into a toner image by the development device 1d using a developer.

When a primary transfer voltage is applied to a primary transfer roller 6d disposed facing the image forming unit Pd across the intermediate transfer belt 20, the toner image formed on the photosensitive drum 3d is primarily transferred onto the intermediate transfer belt 20.

A small amount of residual primary transfer toner remaining on the photosensitive drum 3d is collected by the photosensitive drum cleaner 4d. Then, the image forming unit Pd is prepared for the following image forming process again.

The intermediate transfer belt 20 is stretched by the inner secondary transfer roller 21, a tension roller 22, and a stretching roller 23 and driven in the direction of the arrow R2 in FIG. 1.

According to the present embodiment, the inner secondary transfer roller 21 also serves as a drive roller for driving the intermediate transfer belt 20.

The above-described image forming process is performed for four different colors in parallel by the image forming units Pa to Pd. This process for each color is performed at a timing when a toner image is superimposed on top of the toner image(s) of the upstream color(s) having been primarily transferred on the intermediate transfer belt 20.

As a result, a full-color toner image is eventually formed on the intermediate transfer belt 20 and conveyed to the secondary transfer portion T2.

After passing through the secondary transfer portion T2, residual secondary transfer toner is collected by a transfer cleaning device 30.

In the above-described conveyance process and the image forming process, at matched timings of the recording material P and the full-color toner image at the secondary transfer portion T2, a secondary transfer is performed.

Subsequently, the recording material P is conveyed to the fixing apparatus 50, and a predetermined pressure and a predetermined amount of heat are applied to the toner image to fix the toner image to the recording material P.

In single-sided image forming, the recording material P with the toner image fixed thereon is discharged onto a discharge tray 120 as it is by a discharge roller 14.

In two-sided image forming, a switching member 110 (also referred to as a flapper or the like) changes the conveyance path from the path leading to the discharge tray 120 to a two-sided printing conveyance path 111, and the recording material P conveyed by the discharge roller 14 is conveyed to the two-sided printing conveyance path 111.

Subsequently, the leading and trailing edges of the recording material P are reversed by a reversing roller 112, and then the recording material P is sent to the conveyance path 114 again via a two-sided printing path 113.

The subsequent conveyance process and a back side image forming process are similar to the above descriptions, and redundant descriptions thereof will be omitted.

### Fixing Apparatus

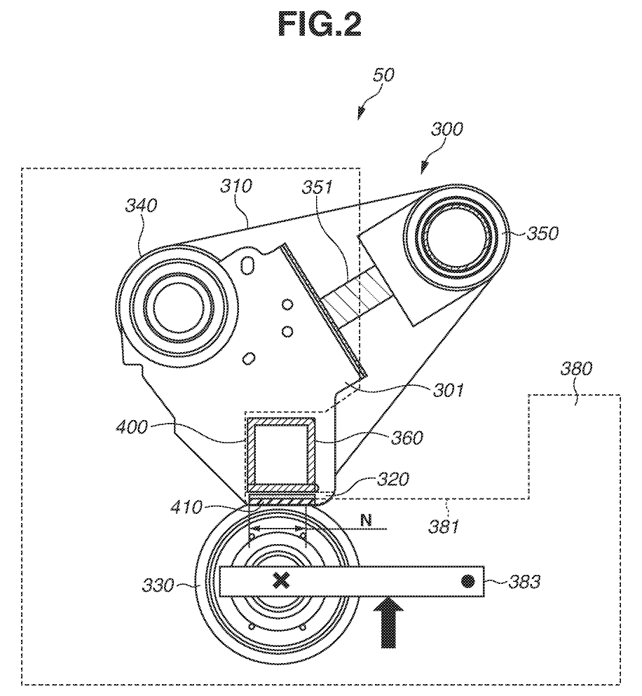

A fixing apparatus 50 according to the present embodiment will now be described with reference to FIG. 2.

As illustrated in FIG. 2, the fixing apparatus 50 according to the present embodiment can be roughly divided into two sections: a belt unit 300 and a pressure roller 330.

The rotation shaft of the pressure roller 330 as a rotating member is supported by a frame 380 of the fixing apparatus 50, and is rotated by a driving source (not illustrated) via a gear or gears.

The pressure roller 330 as a contact member is configured to be in contact with the outer circumferential surface of the fixing belt 310 of the belt unit 300 to press the fixing belt 310.

The pressure roller 330 is movable between a pressure position where the pressure roller 330 is in contact with the fixing belt 310 to press the fixing belt 310 and a non-pressure position where the pressure roller 330 is separated from the fixing belt 310 not to press the fixing belt 310.

To allow the pressure roller 330 to move between the pressure and the non-pressure positions, the pressure roller 330 is supported by a pressure lever 383 that is swung by a pressure motor (not illustrated).

Examples of the applicable pressure roller 330 include an elastic layer made of silicone rubber, fluoro rubber, fluorocarbon resin, or the like as an outer circumferential layer of the metallic rotation shaft (core metal), and a release layer made of a fluorocarbon resin, such as polytetrafluoroethylene (PTFE), perfluoroalkoxy alkane (PFA), or fluorinated ethylene propylene (FEP) as an outer circumferential layer of the elastic layer.

The pressure roller 330 according to the present embodiment includes an elastic layer made of silicone rubber with a 3-mm thickness, and a release layer made of PFA with a 30-μm thickness.

### Belt Unit

As illustrated in FIG. 2, the belt unit 300 mainly includes the rotatable fixing belt 310 having an endless (cylindrical) shape and flexibility, a heating roller 340, a steering roller 350, and a pressure pad member 400 (hereinafter referred to as a pad member 400).

According to the present embodiment, the fixing belt 310 is stretched by the heating roller 340, the steering roller 350, and the pad member 400.

The fixing belt 310 may be a belt including an elastic layer having high thermal conductivity and low heat capacity, for example, a resin belt made of resin, or a belt having a complex layer structure formed of a base layer as a stainless steel (Steel Use Stainless (SUS)) metallic belt or another kind of metallic belt, and an elastic layer, a release layer, and another type of layer as outer circumferential layers over the base layer.

The present embodiment uses the fixing belt 310 formed of a SUS base layer, an elastic layer made of silicone rubber having a heat conductivity of about 1.0 W/mK with a thickness of about 250 μm, and a release layer made of a PFA tube with a 30-μm thickness.

It is desirable for the release layer to be a sheet or a coating layer having high releasing properties. For example, a fluorocarbon resin, such as PFA and PTFE, is applicable.

Examples of the applicable fixing belt 310 also include a belt formed of a base layer made of sheet-like member having high heat resistance (represented by polyester, polyethylene terephthalate, polyimide amide, or the like), a conductive layer over the base layer, and a surface release layer over the conductive layer.

Examples of the fixing belt 310 according to the present specification include a thin film-like belt.

The heating roller 340 is, for example, a stainless steel pipe with a 1-mm thickness including a halogen heater (not illustrated) therein.

Although not illustrated, the heating roller 340 is rotated by a driving source (not illustrated) via a gear or gears.

The fixing belt 310 is driven to rotate following the rotation of the heating roller 340.

When the heating roller 340 is heated by the halogen heater, the temperature of the fixing belt 310 rises via the heating roller 340.

The fixing belt 310 is adjusted to a predetermined target temperature preset according to the type of the recording material P subject to image forming, based on detection results of a temperature sensor (not illustrated), such as a thermistor.

The steering roller 350 outwardly presses the fixing belt 310 from the inside thereof to stretch the fixing belt 310 with a predetermined tension.

The steering roller 350 therefore is biased by a spring 351.

In this way, the steering roller 350 has a function of applying a predetermined tension to the fixing belt 310.

The steering roller 350 steers the fixing belt 310 by using the center portion or one end of the steering roller 350 in the rotational axis direction (widthwise direction) as a rotational fulcrum, thus controlling the meandering of the fixing belt 310 in the rotational axis direction.

More specifically, the steering roller 350 also has a function of controlling the deviation of the fixing belt 310.

The pad member 400 is disposed on the inner circumferential surface of the fixing belt 310 facing the pressure roller 330 across the fixing belt 310. The pad member 400 includes a stay 360, a holding member 320, and a slide member 410. Particularly, the holding member 320 and the slide member 410 may be collectively referred to as a pad member.

The stay 360, a rigid metallic member, such as a stainless steel, extends in the widthwise direction along the fixing belt 310 to support the holding member 320 so that the holding member 320 is attachable on the side of the pressure roller 330.

The holding member 320 supports the slide member 410 so that the slide member 410 is attachable on the side of the pressure roller 330. The holding member 320 is a resin member formed extending in the widthwise direction intersecting with the rotational direction of the fixing belt 310 along the stay 360. For example, the holding member 320 is made of a material having favorable insulation and heat resistance, such as a phenol resin, polyimide resin, polyamide resin, polyamide-imide resin, polyetheretherketone (PEEK) resin, polyethersulfone (PES) resin, polyphenylene sulfide (PPS) resin, PFA resin, PTFE resin, liquid crystal polymer (LCP) resin, or the like.

The slide member 410 slides with the inner circumference surface of the fixing belt 310. The slide member 410 is fixed to the stay 360 with screws via the holding member 320. The slide member 410 may be integrated with the holding member 320. The slide member 410 may be partly fix to the stay 360 or the holding member 320. For example, the slide member 410 may be fixed to the holding member 320 with screws through screw fastening holes 420 at both widthwise ends of the slide member 410.

According to the present embodiment, the slide member 410 attached to the holding member 320 supported by the stay 360 is in contact with the inner circumference surface of the fixing belt 310 to press the fixing belt 310 from the inner circumferential surface toward a fixing nip portion N.

This reliably forms the fixing nip portion N where the recording material P with a toner image formed thereon is subjected to pressure and heat while being pinched and conveyed.

Since the slide member 410 and the holding member 320 are supported by the stay 360 having high rigidity, warpage in the slide member 410 caused by the pressure of the pressure roller 330 is reduced. This configuration provides a uniform nip width in the rotational axis direction of the pressure roller 330.

It is desirable for a lubricant, such as silicone oil, to be applied between the slide member 410 and the fixing belt 310 to allow the fixing belt 310 and the slide member 410 to smoothly slide with each other.

### Slide Member

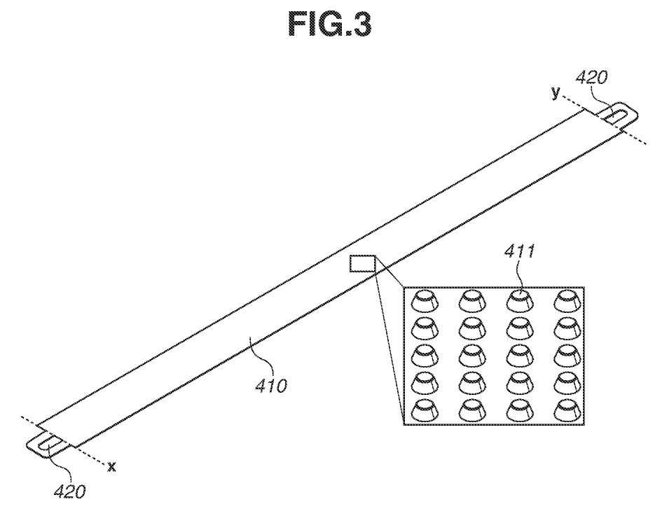

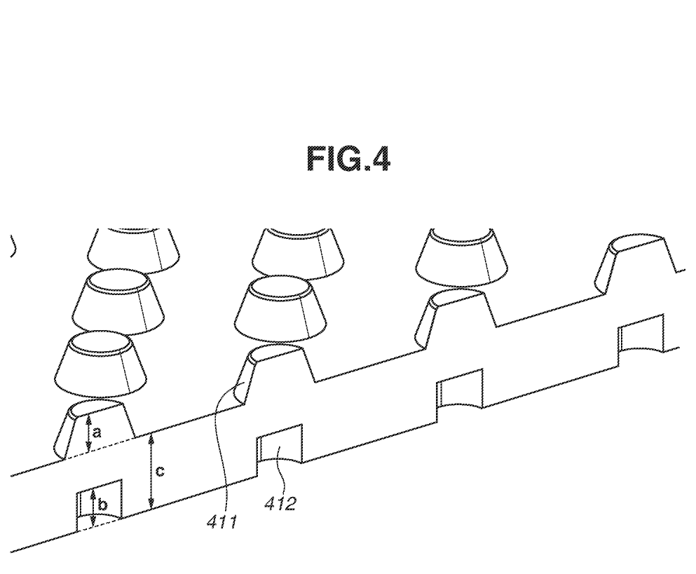

The slide member 410 as a feature of the present disclosure will now be described with reference to FIGS. 3 and 4.

These drawings are schematically illustrated for the conveyance of description; therefore shapes, sizes, and layouts of actual objects are not necessarily faithfully illustrated.

FIG. 3 is a schematic perspective view illustrating the slide member 410. On the slide member 410, a region α is a region on which the slide member 410 is held by the holding member 320. The region α ranges from a broken line x to a broken line y in FIG. 3, which is the region excluding the parts forming the screw fastening holes 420 at both widthwise ends of the slide member 410. The broken lines x and y denote widthwise ends where the slide member 410 is held by the holding member 320.

As illustrated in FIG. 3, a plurality of projecting portions 411 each having a protruding shape is formed on the slide surface of the slide member 410. The projecting portions 411 may be referred to as embossed portions.

The projecting portions 411 form the slide surface with the fixing belt 310, and are designed to hold a lubricant and reduce the contact area so that the coefficient of friction with the inner circumferential surface of the fixing belt 310 does not exceed a predetermined value.

The projecting portions 411 are not limited in shape and may have a column shape, rectangular column shape, hemispherical shape, and any other desired shapes as long as the projecting portions 411 can reduce the contact area and hold the lubricant. The presence or absence of corner radii or tapers is not limited either.

Of various shapes, a frusto-conical shape illustrated in FIG. 3 may be desirable. In particular, a top edge diameter of Φ0.15 to Φ0.45 mm, a height (a) of 0.15 to 0.3 mm, and a taper angle of 5 to 50 degrees are effective in the current example.

A constant taper angle is desirable in some embodiments. Especially, increasing the taper angle of skirts of the projecting portions 411 needs to be avoided because such skirts increase their cross-sections and will increase the heat conduction efficiency.

In some embodiments, the slide member 410 has a thickness (c) of 0.4 to 1.4 mm.

The projecting portions 411 may be disposed in any desired form. However, disposing them too densely increases the contact area, which will increase the friction coefficient. Conversely, disposing them too sparsely may possibly cause warpage in the fixing belt 310. It is desired for the projecting portions 411 of some embodiments to be disposed at intervals of 0.5 to 3.0 mm on the premise that they do not interfere with each other. The distance (interval) between the centers of adjacent projecting portions 411 in the conveyance direction is 1.0 mm or more. In some embodiments, it is desired for the area of the top surface of each projecting portion 411 (the area of the apical shape of each embossed portion) S to be 0.031 mm².

FIG. 4 is a perspective cross-sectional view illustrating a feature of the slide member 410.

As illustrated in FIG. 4, recessed portions 412 each having a recessed shape are formed in phase with the projecting portions 411 of the slide member 410, in the back surface of the projecting portion 411.

To reduce variations in thickness, the recessed portions 412 are formed at positions overlapping in a direction perpendicularly intersecting with the recording material conveyance direction, and have a similar shape to a projecting portion 411. In some embodiments, it is desired for the recessed portion 412 to have a depth (b) of 0.15 to 0.3 mm. Especially, it is desired in some embodiments for the projection shape viewed from the vertical direction to be a circular shape having a diameter of Φ0.15 to Φ0.45 mm. This is because the circular shape prevents concentration of stress.

The recessed portions 412 are each formed in a dimensional range suitable for a projecting portion 411.

The outer circumferential edge of each recessed portion 412 is within a more centrally inward range than the base portion edge of the taper of the projecting portion 411.

In some embodiments, it is desired for the distance from the base portion edge of the taper to the hole bottom edge of the recessed portion 412 to be 80 to 30% of the thickness.

A configuration with the distance being 80% or more of the thickness provides almost no heat-insulating performance. A configuration with the relevant distance being 30% or less of the thickness provides reduced rigidity, which may result in damage to the embossed portion.

According to the present embodiment, the number of projecting portions 411 is equal to the number of recessed portions 412 in the region α. However, to improve the heat-insulating performance, the recessed portions 412 may be formed so that the number of recessed portions 412 exceeds the number of projecting portions 411 to increase more air layers. Specifically, the number of recessed portions 412 in the surface in contact with the holding member 320 may be equal to or larger than the number of projecting portions 411 on the surface to slide with the inner circumferential surface of the fixing belt 310. Since the recessed portions 412 serve as air layers for preventing the heat from being transmitted from the projecting portions 411 in contact with the fixing belt 310 that transmits heat the most to the holding member 320, the recessed portions 412 are formed at positions overlapping with the projecting portions 411 in the direction perpendicularly intersecting with the conveyance direction. With more recessed portions 412 formed than the projecting portions 411, additional recessed portions 412 are formed between the recessed portions 412.

The slide member 410 is mainly made of a metallic material having favorable strength, rigidity, slidability, and heat resistance.

Examples of the material include iron, aluminum, aluminum alloys, copper, and copper alloys, each of which secures a desired load-bearing capacity.

Examples of iron include stainless steels, such as SUS304 and SUS316, mild steels, such as Steel Plate Cold Commercial (SPCC) and Steel Plate Cold-rolled Extra deep drawing quality (SPCE), and carbon steels for general structures, such as SS400.

Plating of zinc, nickel, copper, and the like or a lubrication coating containing fluorocarbon resin, graphite, and the like may be applied to these steels.

Examples of aluminum include A1100 and A1050, examples of aluminum alloys include A2017 and A5052 (including anodized products), examples of copper include C1100, and examples of copper alloys include C2700 and C2801.

An exemplary method for manufacturing the slide member 410 will now be described.

The slide member 410 may be manufactured by using any desired method, such as press forming.

An upper die and a lower die having reversed shapes corresponding to the shapes of a projecting portion 411 and a recessed portion 412, respectively, are produced, and then a plate material is pressed using those dies to obtain formed products.

Roll forming is also applicable.

Reversed shapes corresponding to a projecting portion 411 and a recessed portion 412 are formed on rolls, and the plate material is sandwiched by the rolls and then rotated while being pressed with the rolls, forming the projecting portions 411 and the recessed portions 412 on the plate material.

In addition, the slide member 410 may also be manufactured by using a removal process.

In a removal process, for example, process techniques, such as cutting, blasting, and laser processing, can be employed alone or in combination.

Specifically, machining equipment, such as machining centers, lathes, milling machines, and low-load electrical discharge machining equipment can be employed.

Examples of process techniques also include etching and a three-dimensional (3D) printing process. The slide member 410 can also be manufactured through a combination of a plurality of the above-described process methods.

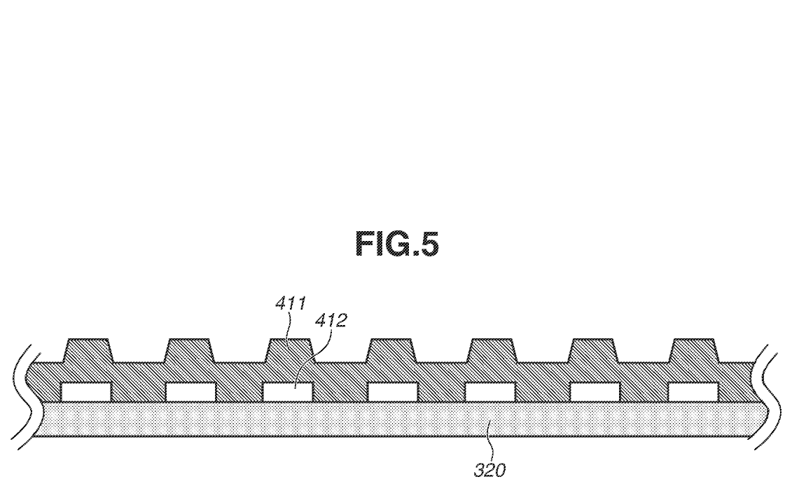

FIG. 5 is a partial cross-sectional view illustrating the slide member 410 and the holding member 320 indicating features of the present disclosure.

As illustrated in FIG. 5, the slide member 410 of the present disclosure has the recessed portions 412. When in the region α of the slide member 410, the area of the supporting surface in contact with the holding member 320 is A, and the area of the surface out of contact with the holding member 320 is B, it is desired for the ratio of the area A to the total area of the region α ((A/(A + B)) × 100%) ranges from 15% to 60%. Use of the configuration according to the present embodiment enables reduction of the area in contact with the holding member 320.

A recessed portion 412 as an air layer has an exemplary heat conductivity of 0.01 to 0.04 W/mK, which is one-tenth to one-hundredth of that of resins and metals.

The amount of heat transfer across a plurality of parts is generally proportional to heat conductivity and contact area, so that the heat-insulating performance of the slide member 410 is increased.

According to the present disclosure, the heat-insulating performance of the slide member 410 can be secured by reducing the contact area between the slide member 410 and another material in contact with the slide member 410 to improve the heat-insulating performance of the slide member 410 without using a heat insulation material.

A second embodiment of the present disclosure will be described.

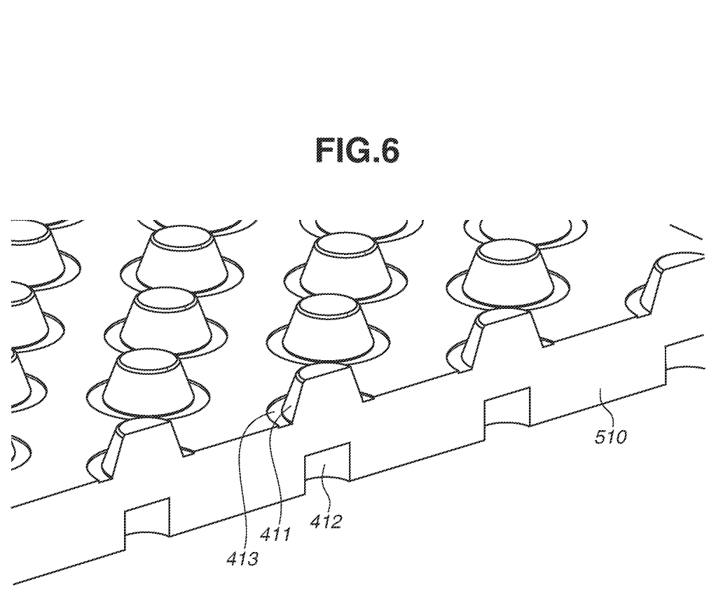

FIG. 6 is a perspective cross-sectional view illustrating a slide member 510 according to the second embodiment of the present disclosure.

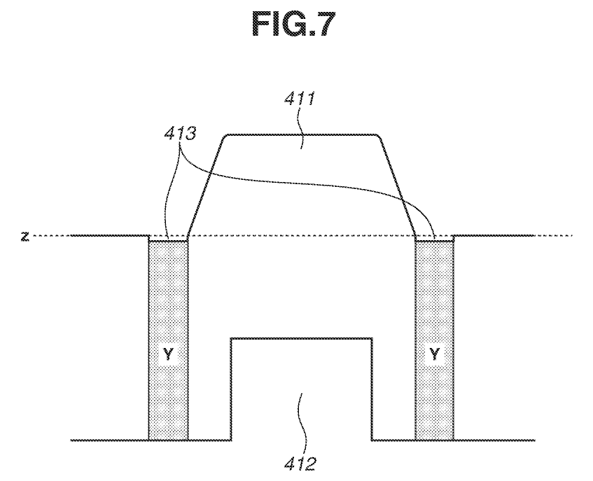

FIG. 7 is a partial cross-sectional view illustrating the circumference of a second recessed portion 413 representing a recessed shape of the slide member 510 according to the second embodiment of the present disclosure.

Unlike the slide member 410, the slide member 510 is provided with the second recessed portions 413 each formed around the corresponding projecting portion 411. The slide member 510 is provided with the projecting portions 411 each projecting toward the inner circumferential surface of the fixing belt 310 with respect to the broken line z as the reference plane, and the second recessed portions 413 recessed toward the holding member 320 with respect to the broken line z. In a cross-sectional view (FIG. 7) taken along a cross-section perpendicularly intersecting with the recording material conveyance direction, a second recessed portion 413 is disposed adjacently to the corresponding projecting portion 411.

The second recessed portion 413 decreases the area of the cross-section Y of the slide member 510 in a thickness direction around the corresponding projecting portion 411 to prevent the heat transfer from the fixing belt 310 via the projecting portion 411, thus producing an effect of improving the heat insulation performance of the slide member 510.

When the slide member 510 is viewed from a direction perpendicularly intersecting with the conveyance direction, the outline of the recessed portion 412 is within a more centrally inward range than the outline of the projecting portion 411. In other words, the size of the circle of the recessed portion 412 is within the circle of the projecting portion 411. The projecting portion 411 increases in size as the diameter approaches the broken line z. The recessed portion 412 is configured so that its diameter is smaller than the smallest diameter of the projecting portion 411.

The second recessed portions 413 according to the second embodiment may each have any shape as long as the cross-section Y can be decreased. In some embodiments, it is desirable for a second recessed portion 413 to have a width of 0.1 to 1.0 mm from the intersection point of the projecting portion 411 and the broken line z, and a depth (d) of 5 to 50 μm. The distance from the base portion edge of a projecting portion 411 to the hole bottom edge of the corresponding recessed portion 412 is 30% or more and 80% or less of the thickness of the slide member 510 excluding the projecting portion 411.

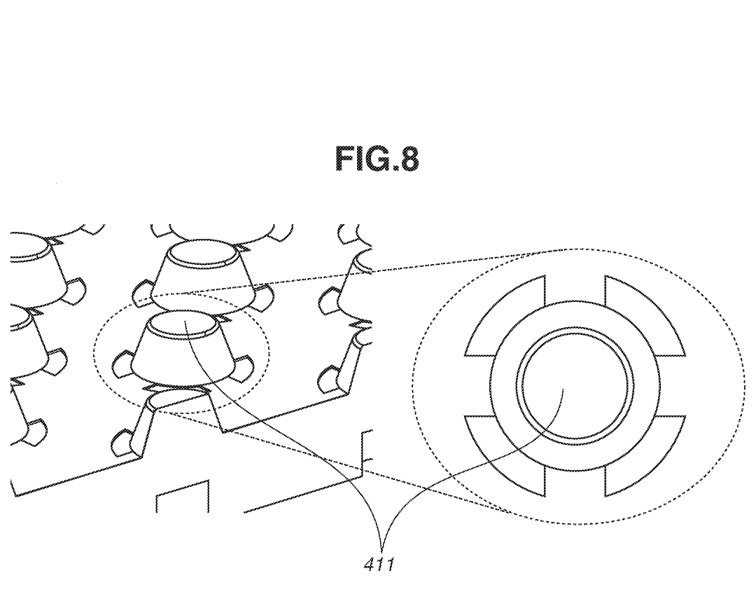

FIGS. 8 to 11 are each a partial top view and a partial cross-sectional view illustrating a different pattern of the second recessed portions 413 according to the second embodiment of the present disclosure.

As illustrated in FIGS. 8 to 11, the second recessed portions 413 each having a recessed shape do not necessarily need to be formed over the entire circumference of the corresponding projecting portion 411, but may be intermittently formed.

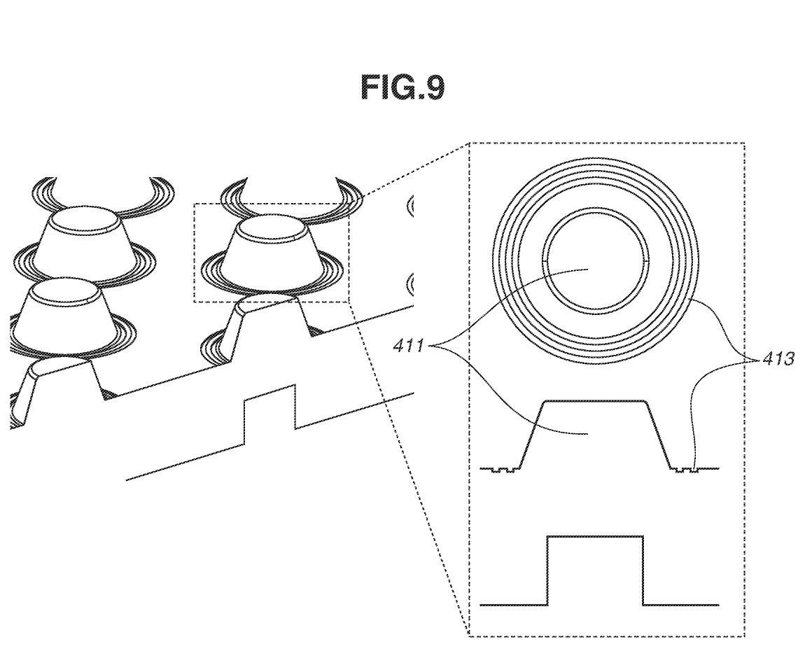

For example, as illustrated in FIG. 8, second recessed portions 413 may each be intermittently disposed in arc form around the corresponding projecting portion 411, or as illustrated in FIG. 9, second recessed portions 413 may each be intermittently disposed in the circumferential direction.

It is evident that any combinations of the shapes in FIGS. 8 and 9 or non-circular shapes may also be employed. Corner radii may be provided on a shape, and a taper may be provided on a wall surface.

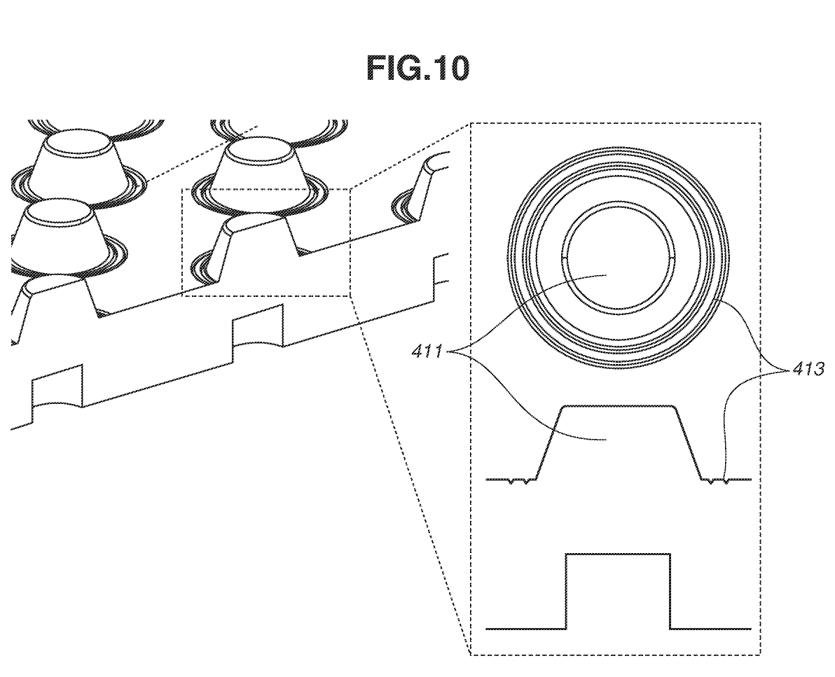

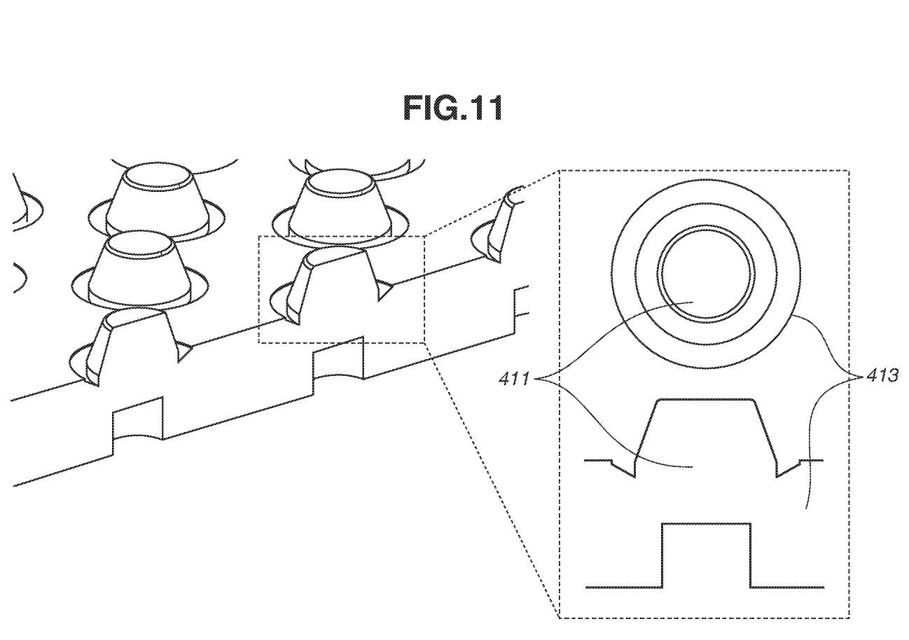

As illustrated in FIGS. 10 and 11, the bottom surface of each recessed portion does not necessarily need to be flat. A V- or U-shaped groove may be provided in the surface, and a plurality of recessed portions each having an acute angle groove in the bottom surface, like a transcription of a pinholder, may be provided in the surface.

A second recessed portion 413 having a recessed shape with a larger opening region has a smaller cross-section Y, providing an improved heat-insulating performance, which may reduce the rigidity.

Thus, it is effective to form a recessed shape having a size not causing interference between recessed shapes around the projecting portion 411 and with the depth of each recessed shape being 50% or less of the thickness of the slide member 510.

Recessed shapes do not need to be formed around all the projecting portions 411 but may be formed at limited positions in consideration of the rigidity and the like.

A second recessed portion 413 may be covered with a lubrication coating in the following process as necessary.

This is because most of the heat transfer does not propagate through the lubrication coating portion but through a metallic material, and occurs in the material of the slide member 510, whose thickness is large.

A method for manufacturing the slide member 510 is also similar to that of the slide member 410. The slide member 510 can be processed with general press forming and removal processing.

The present embodiment enables reducing the thickness around a projecting portion 411 to further improve the heat-insulating performance of the slide member 510.

### Manufacturing Method

A method for manufacturing the slide member 410 will be described in detail.

It is most effective to manufacture the slide member 410 using press forming.

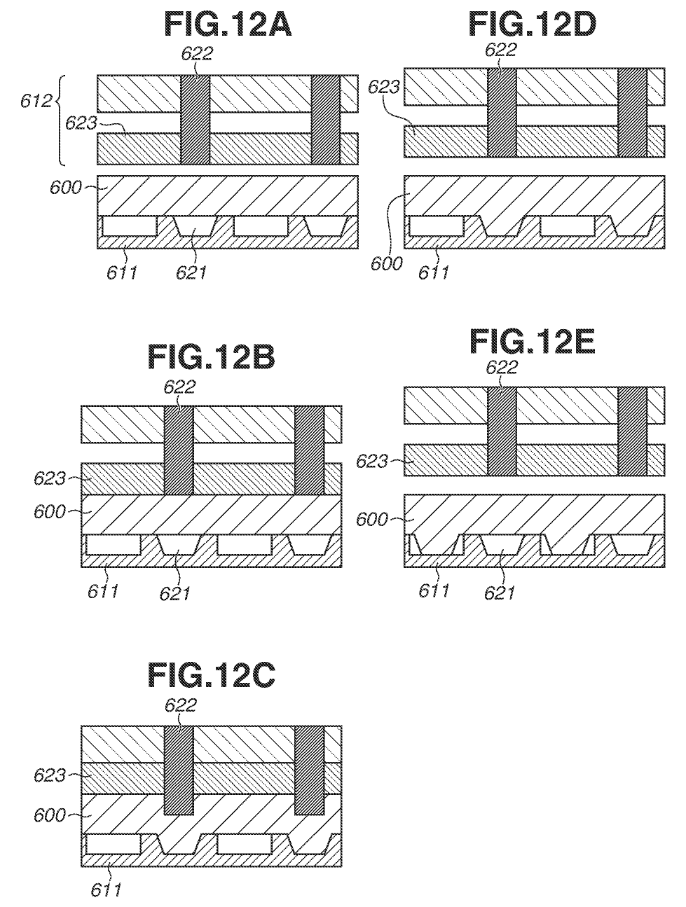

FIGS. 12A to 12E are schematic cross-sectional views illustrating the method for manufacturing the slide member 410 using press forming.

As illustrated in FIG. 12A, a plate material 600 as a material to be processed, a lower die 611, and an upper die 612 are prepared.

The lower die 611 has hole shapes 621 each as a reversed shape corresponding to a projecting portion 411, and is manufactured with a material having higher hardness than that of the metallic plate material 600.

For example, if the plate material 600 is a stainless steel, the material of the lower die 611 is a high-speed steel (SKH61 or powdered high-speed steel), a cemented carbide, and the like.

Although not illustrated, when providing the second recessed portion 413 around the projecting portion 411, a reversed shape corresponding to the second recessed portion 413 can be disposed in the lower die 611.

Likewise, the upper die 612 includes a punch 622 as a reversed shape corresponding to the recessed portion 412.

It is desirable for the punch 622 to be manufactured as a different part from the upper die 612.

The punch 622 is a position where mechanical stress is applied during the press forming. If the punch 622 is damaged, the punch 622 alone needs to be replaced.

This eliminates the need for producing the entire upper die 612 by using a material having high hardness. For example, the punch 622 alone can be made of a cemented carbide, and other portions made of materials having low hardness.

It is desirable for the center position of the hole shape 621 to coincide with the center position of the punch 622.

Even if a deviation occurs, the end edge of the punch 622 is within a more inward range than the outer shape edge of the hole shape 621.

If the end edge of the punch 622 is outside the outer shape edge of the hole shape 621, the force applied to the punch 622 during the press forming disperses in the pressing surface to ununiformly deform the punch 622, which may cause damage to the punch 622.

It is also effective for a plate pressing member 623 to be provided in the upper die 612.

The plate pressing member 623 applies a downward pressure with a spring (not illustrated) to prevent the deformation and/or shift of the material to be processed. The plate pressing member 623 has a role of removing the material subjected to process adhering to the punch 622.

FIG. 12B illustrates an intermediate step of the press forming.

The lower die 611 and the upper die 612 vertically sandwich the plate material 600. At this timing, the plate pressing member 623 firstly comes into contact with the plate material 600 to fix the position of the plate material 600.

Then, the press forming is performed by the punch 622 as illustrated in FIG. 12C.

At this timing, the plate pressing member 623 can reduce the deformation of the plate material 600.

In the press forming, since die shapes are transcribed with relatively high accuracy, excessive portions around protruding shapes can be minimized unlike etching.

FIG. 12D illustrates a state where the initial press forming is completed.

The use of the plate pressing member 623 enables removing the punch 622 from the plate material 600 after the successful press forming.

FIG. 12E illustrates a state where the material to be processed has been moved in a planer direction for the next press forming.

In the press forming of the slide member 410, it is effective to move the plate material 600 to different positions after press forming to obtain formed parts multiple times to form required numbers of protruding and recessed shapes in a separate way.

This sequence enables reducing the process time of the hole shape 621 and the number of parts of the punch 622 that affect the process cost of dies.

The above-described press forming allows the metallic plate material 600 to have the projecting portions 411 formed on the front surface and the recessed portions 412 in the back surface as essential portions of the slide member 410.

Subsequently, deformation in the slide member 410 caused in the press forming is corrected (warpage correction), screw fastening holes, positioning geometries, and the like for attaching the slide member 410 to the holding member 320 are processed, and a surface process is performed as necessary. This completes the manufacturing of the slide member 410.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Applications No. 2024-177948, filed October 10, 2024, and No. 2025-068458, filed April 17, 2025, which are hereby incorporated by reference herein in their entirety.

What is claimed is:

1. A fixing apparatus for fixing a toner image borne on a recording material to the recording material at a nip portion, the fixing apparatus comprising:
a rotatable endless belt configured to heat the recording material;
a pressure roller configured to abut an outer circumferential surface of the belt, and configured to press the belt; and
a pad member disposed inside an inner circumference surface of the belt, the pad member facing the pressure roller across the belt, and configured to form the nip portion between the belt and the pressure roller,
wherein the pad member includes a contact member in contact with the inner circumference surface of the belt, and a holding member that holds the contact member,
wherein the contact member has a plurality of projecting portions on a first surface of the contact member, the first surface being to slide with the inner circumferential surface of the belt, and a plurality of recessed portions in a second surface of the contact member, the second surface being to be in contact with the holding member,
wherein, in a direction perpendicularly intersecting with a conveyance direction, an outline of each of the plurality of recessed portions is within a more centrally inward range than an outline of a base portion of each of the plurality of projecting portions, and
wherein a depth of a deepest portion of each of the recessed portions in the direction perpendicularly intersecting with the conveyance direction is shorter than a thickness of the contact member with respect to a predetermined reference plane where neither a projecting portion nor a recessed portion is formed.

2. The fixing apparatus according to claim 1, wherein a region where the contact member and the holding member are in contact with each other is 15% or more and 60% or less of the area of the contact member.

3. The fixing apparatus according to claim 1, wherein the contact member is made of a metal.

4. The fixing apparatus according to claim 1, wherein each of the plurality of recessed portions is circular when viewed in the direction perpendicularly intersecting with the conveyance direction of the recording material.

5. The fixing apparatus according to claim 1, wherein each of the plurality of projecting portions is circular when viewed in the direction perpendicularly intersecting with the conveyance direction of the recording material.

6. The fixing apparatus according to claim 1, wherein the number of the plurality of recessed portions in the second surface in contact with the holding member is equal to or greater than the number of the plurality of projecting portions on the first surface to slide with the inner circumferential surface of the belt.

7. The fixing apparatus according to claim 1, wherein the number of the plurality of projecting portions on the first surface to slide with the inner circumferential surface of the belt is equal to the number of the plurality of recessed portions in the second surface in contact with the holding member.

8. The fixing apparatus according to claim 1,
wherein the contact member has the plurality of projecting portions projecting toward the inner circumferential surface of the belt with respect to a predetermined reference plane, and a second recessed portion recessed toward the holding member with respect to the predetermined reference plane, and
wherein the second recessed portion is disposed adjacently to each of the plurality of projecting portions.

9. The fixing apparatus according to claim 8, wherein the second recessed portion is formed around each of the plurality of projecting portions.

10. The fixing apparatus according to claim 8, wherein the second recessed portion is intermittently formed around each of the plurality of recessed portions.

11. The fixing apparatus according to claim 1, wherein, when the contact member is viewed from the direction perpendicularly intersecting with the conveyance direction, the outline of each of the plurality of recessed portions is within a more centrally inward range than the outline of a corresponding projection portion of the plurality of projecting portions.

12. The fixing apparatus according to claim 1, wherein a distance from a base portion edge of each of the plurality of projecting portions to a hole bottom edge of a corresponding recessed portion of the plurality of recessed portions is 30% or more and 80% or less the thickness of the contact member excluding a corresponding projecting portion of the plurality of projecting portions.

13. A method for manufacturing a contact member, the method comprising:
preparing a plate material; and
performing press forming and movement of the plate material in a planar direction a plurality of times to repetitively form a projecting portion on the plate material and a recessed portion in the plate material, the press forming being performed by sandwiching the plate material between a first die having a plurality of recessed shapes formed therein and a second die having a punch disposed so that an outline of a portion of the punch in contact with the plate material is within a more inward range than the outline of a recessed shape of each of the plurality of recessed portions in a vertical direction.

14. A fixing apparatus for fixing a toner image borne on a recording material to the recording material at a nip portion, the fixing apparatus comprising:
a rotatable endless belt configured to heat the recording material;
a pressure roller configured to abut an outer circumferential surface of the belt, and configured to press the belt; and
a pad member disposed inside an inner circumference surface of the belt, the pad member facing the pressure roller across the belt, and configured to form the nip portion between the belt and the pressure roller,
wherein the pad member includes a contact member in contact with the inner circumference surface of the belt, and a holding member that holds the contact member, and
wherein the contact member is formed by press forming on a metallic plate material so that the contact member has a plurality of projecting portions on a first surface of the contact member, the first surface being to slide with the inner circumferential surface of the belt, and a plurality of recessed portions in a second surface of the contact member, the second surface being to be in contact with the holding member.
